(19) United States
(12) Patent Application Publication
(10) Pub. No.: US 2011/0085709 A1
(43) Pub. Date: Apr. 14, 2011

(54) CONTACT HISTORY RECORDING SYSTEM, CONTACT HISTORY RECORDING METHOD AND IMAGE PROCESSING APPARATUS

(75) Inventors: Yukio WATANABE, Tokyo (JP); Shunichi Kumakura, Tokyo (JP); Motoaki Aoyama, Tokyo (JP)

(73) Assignee: KONICA MINOLTA BUSINESS TECHNOLOGIES, INC., Tokyo (JP)

(21) Appl. No.: 12/898,823

(22) Filed: Oct. 6, 2010

(30) Foreign Application Priority Data
Oct. 14, 2009 (JP) JP2009-237605

(51) Int. Cl. G06K 9/00

(52) U.S. Cl. 382/115

(57) ABSTRACT

A contact history recording system for recording a contact history for each of target portions in an apparatus in cases of being contacted by a person, including: a plurality of transmitters, each installed at each of the target portions; and a receiver which communicates with the plurality of transmitters, wherein each transmitter includes: a memory section which previously stores individual identification information of a target portion where a transmitter is installed; and transmitting section which transmits the individual identification information stored in the memory section in cases where the target portion where the transmitter is installed is contacted by a person, and wherein the receiver includes: a receiving section which receives the individual identification information transmitted from the transmitter; and a control section which inputs the individual identification information received by the receiving section to a recording section to record the inputted individual identification information.

### CROSS REFERENCE TO RELATED APPLICATION

The present application is based on Japanese Patent Application No. 2009-237605 filed with Japanese Patent Office on Oct. 14, 2009, the entire content of which is hereby incorporated by reference.

### BACKGROUND OF THE INVENTION

1. Technical Field

The present invention relates to a contact history recording system, a contact history recording method and an image processing apparatus which record a contact history in cases where an apparatus is touched by a person.

2. Background Technology

There are some electronic apparatuses such as personal computers which are capable of recording a history of disassembling the apparatuses by a user.

For example, in an apparatus disclosed in Unexamined Japanese Patent Application Publication No. 2007-128199, the apparatus detects with a detector that a bottom cover of a personal computer is removed, and stores the detection history (disassembling history) in a memory. Thus a service person is enabled to know whether or not a user removed the bottom cover, which being helpful for specifying a cause of trouble. In this apparatus, the detector is configured with such as a wiring pattern which switches between conduction and non-conduction states, or a button switch which switches between on/off states according to attachment/removal of the bottom cover.

Configurations as the above described technology, where removal of the component part is detected by the wiring pattern or the button switch, requires an exclusive wiring for each detection section, in cases where individual detector is provided for each of plurality of parts. Thus, the structure of the wiring pattern or wiring paths for the switch becomes complicated, which may restrict a space or a layout for installing the detectors or installable number of parts. Further necessity of many wiring may cause increased cost. Therefore it may be difficult to obtain a detailed contact history as to what part of the apparatus a user has touched or removed, and this causes a problem that effective information cannot be obtained for specifying the cause of failure.

An objective of the present invention is to solve the above described problem, and to provide a contact history recording system, contact history recording method and image processing apparatus that enable the detection of being contacted by a person with wireless system and the recording of contact history.

### SUMMARY

A system reflecting one aspect of the present invention is a contact history recording system for recording a contact history for each of target portions of contact detection in an apparatus in cases where the apparatus is contacted by a person, the system including: a plurality of transmitters, each installed at each of the target portions; and a receiver which communicates with the plurality of transmitter,

wherein each of the plurality of transmitters comprises: a memory section which previously stores individual identification information of a target portion where a transmitter of the plurality of transmitters is installed; and a transmitting section which transmits the individual identification information stored in the memory section in cases where the target portion where the transmitter is installed is contacted by a person, and

wherein the receiver comprises: a receiving section which receives the individual identification information transmitted from the transmitter; and a control section which inputs the individual identification information received by the receiving section to a recording section to record the inputted individual identification information.

In the above-described contact history recording system, it is preferable that the control section inputs clock time information indicating a clock time of receiving the individual identification information by the receiving section to the recording section, by correlating to the individual identification information.

In the above-described contact history recording system, it is preferable that the receiver includes an acquisition section to acquire personal identification information of the person, and the control section inputs the personal identification information acquired by the acquisition section into the recording section.

In the above-described contact history recording system, it is preferable that the system is provided with an electrode connected with the receiving section, the electrode being connected to a portion of a human body of the person other than a portion with which the person touches the target portion,

wherein the transmitter and the receiver form a communication path including the human body of the person between one another, and execute transmission and receiving of the individual identification information via the communication path in cases where the human body connected with the electrode contacts the target portion.

In the above-described contact history recording system, it is preferable that the transmitter and the receiver execute transmission and receiving of the individual identification information via radio communication.

In the above-described contact history recording system, it is preferable that the transmitter comprises power generation element which generates electric power in cases of being touched by a person and supplies the electric power to the transmitting section, and

wherein the transmitting section transmits the individual identification information in cases of receiving the power supplied by the power generation element.

A method reflecting one aspect of the present invention is a contact history recording method for recording a contact history for each of target portions of contact detection in an apparatus in cases where the apparatus is contacted by a person, the method including the steps of:

transmitting previously stored individual identification information of a target portion, from a transmitter installed at the target portion contacted by a person among a plurality of transmitters each installed at each of the target portions;

receiving by a receiver the individual identification information transmitted from the transmitter; and

recording the individual identification information received by the receiver in a recording section.

### BRIEF DESCRIPTION OF THE DRAWINGS

These and other objects, advantages and features of the invention will become apparent from the following description thereof taken in conjunction with the accompanying drawings in which:

FIG. 1 is an appearance diagram showing a multi functional peripheral as an image processing apparatus provided with a contact history recording system relating to the first embodiment of the present invention;

FIG. 2 is a block diagram showing a configuration of a control system of multi functional peripheral relating to the first embodiment of the present invention;

FIG. 3 is a block diagram showing a configuration of a receiver in the contact history recording system relating to the first embodiment of the present invention;

FIG. 4 is a block diagram showing a configuration of a transmitter in the contact history recording system relating to the first embodiment of the present invention;

FIG. 5 is a block diagram showing a configuration of a terminal apparatus relating to the first embodiment of the present invention;

FIG. 6 is an appearance diagram showing an installation position in a case of installing the transmitter at a movable lever in the multi functional peripheral;

FIG. 7 is an appearance diagram showing an installation position in a case of installing the transmitter at an imaging unit in the multi functional peripheral;

FIG. 8 is flow diagram showing an ID transmitting operation of the transmitter installed at a part in the multi functional peripheral;

FIG. 9 is flow diagram showing an ID receiving operation of the receiver in the multi functional peripheral;

FIG. 10 is a diagram showing a log database recorded in the recording section of the receiver;

FIG. 11 is a block diagram showing a configuration of a control system of multi functional peripheral relating to the second embodiment of the present invention;

FIG. 12 is a block diagram showing a configuration of a receiver in the contact history recording system relating to the second embodiment of the present invention;

FIG. 13 is a block diagram showing a configuration of a transmitter in the contact history recording system relating to the second embodiment of the present invention; and

FIG. 14 is a block diagram showing a configuration of a receiver in the contact history recording system relating to the third embodiment of the present invention.

### DETAILED DESCRIPTION OF THE PREFERRED EMBODIMENTS

Embodiments of the present invention will be described below.

### First Embodiment

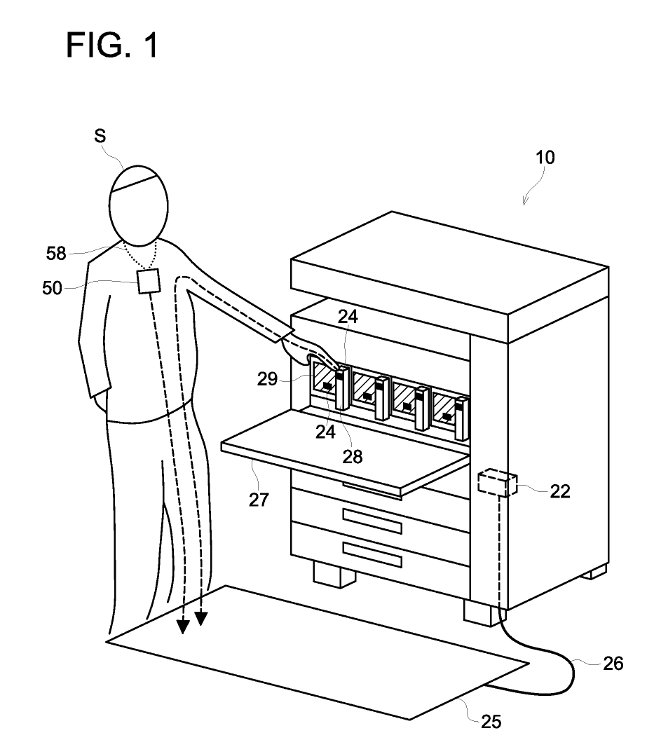

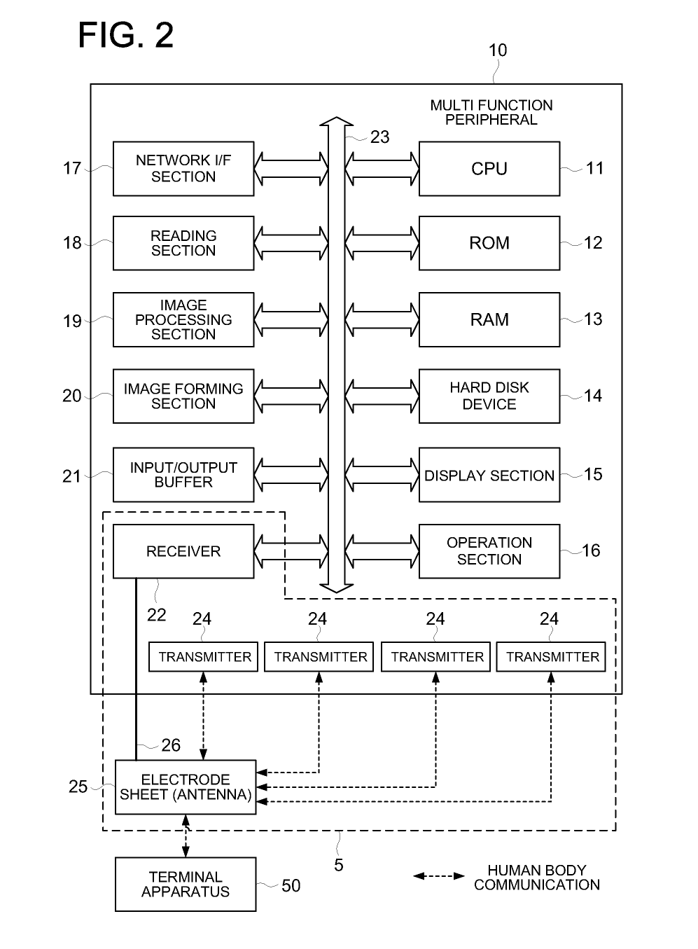

FIG. 1 and FIG. 2 are diagrams showing a multi functional peripheral 10 as an image processing apparatus provided with a contact history recording system 5 relating to the first embodiment of the present invention. FIG. 1 is an appearance diagram of the multi functional peripheral 10, and FIG. 2 is a block diagram showing a configuration of the control system in the multi functional peripheral 10.

Multi functional peripheral 10 is provided with functions such as a copying function to optically read an image of an original document and output by printing a reproduced image on a recording sheet, a scanning function to store the read-out data as a file and sends to an information processing terminal such as a personal computer, printer function to print an image relating to print data received from the information terminal on a recording sheet, and a facsimile function to transmit and receive the image data.

On multi function peripheral 10, in cases where paper jam or other error occurred in the course of operation with the above various functions, a user may conduct a release work of the error by contacting the inside of multi function peripheral 10. Even in a case of the error whose cause cannot be easily specified, if it is urgently required, a user may forcedly conduct the releasing work without waiting for a service person. In such the case where the cause cannot be easily specified, or the position of the error is deep inside the apparatus, the user may possibly touches or removes the many parts in multi function peripheral 10.

Contact history recording system 5 of multi function peripheral 10 is the system which enables the service person to obtain effective information in order to specify the cause of error (or failure) by recording the contact history (or disassembling history) regarding the plural parts in multi function peripheral 10. To be more detail, contact history system 5 records the contact history, in the case of having been touched by a person (user, etc.), for each target portion (each target part) in multi function peripheral 10. And contact history recording system 5 is provided with a plurality of transmitters 24 each installed for each target portion, and receiver 22 to communicate with this plurality of transmitters 24. Transmitter 24 transmits the previously memorized individual identification information (individual ID) when said transmitter 24 installed at the target portion is touched by a person. Receiver 22 receives and records the individual identification information sent from transmitter 24, to record the contact history regarding the target portion of the contact detection.

Further, as shown in FIG. 1, a specific person S such as a service person and an administrator possesses terminal apparatus 50 for personal identification, but common users do not possess terminal apparatus 50. Terminal apparatus 50 previously memorizes personal identification information (personal ID) of specific person S who possesses said terminal apparatus 50, and is provided with a function of communicating with receiver 22. In cases where specific person S touches the target portion of the contact detection, receiver 22 receives and records the personal identification information in terminal apparatus 50, thus the history of contact person (specific person S) with respect to the target portion is recorded.

In the present embodiment, the above mentioned identification information is transmitted and received between transmitter 24 and receiver 22, and between terminal apparatus 50 and receiver 22 by utilizing the human body communication technology to execute the communication by applying the human body as the communication path.

The human body communication is a communication technology to conduct short distance data communication by utilizing the human body as the communication path, and there are electric current system, electric field system and the like.

An electric current system is a system that conducts communication by passing a weak electric current (alternate current) through a human body, and by superposing the data (information) on the electric current. In the case of utilizing the terminal apparatus, only by touching the electrode of the apparatus (electronic equipment) of communication target with a hand installed with the terminal apparatus such as watch type apparatus, the data communication is enabled between the apparatuses.

An electric field system is a system where by generating an electric field near a human body, the human body as a dielectric substance is dielectrically polarized, the whole human body becomes a communication path enveloped with the electric field, and the data communication is conducted through the communication path of the electric field induced near the human body (surface of the human body). The system utilizes the electric field as the medium of data signals.

In the case of using the terminal apparatus, for example, a weak electric field is induced through applying a voltage (alternate voltage) with the electrode of the terminal apparatus on the surface of the human body, the electric field spreads around the surface of the human body, and when the surface of the human body contacts (or comes close to) the electrode of the apparatus of communication target, an electric potential is induced by the electric field. By detecting with an electric field sensor the electric potential change induced on the electrode with this electric field change, and by converting the electric potential change into electrical signals, the data communication is conducted in this system. In the present embodiment, this electric field system is used.

The terminal apparatus may be configured with various shapes of easily portable for the owner of the apparatus such as a card type, a watch type, or a key type. For example, in a case where the terminal apparatus is embedded in an identification card to be configured with a card type, the specific person S can wear the card type terminal apparatus around the neck as shown in FIG. 1, or keep in pocket to carry along. In the case of watch type, the person can carry along the apparatus by putting on the wrist.

As shown in FIG. 2, multi functional peripheral 10 is configured with CPU (Central Processing Unit) 11 to control the movement of the peripheral 10, ROM (Read Only Memory) 12, RAM (Random Access Memory) 13, hard disc device 14, display section 15, operation section 16, network I/F (Interface) section 17, reading section 18, image processing section 19, image forming section 20, input/output buffer 21, and receiver 22, all of these being connected through bus 23. Further, in multi functional peripheral 10, target portions of contact detection are predetermined, and a plurality of transmitters 24, each being installed at each of the target portions, is provided. Further multi functional peripheral 10 is provided with electrode sheet 25 for performing the function as an antenna of receiver 22, and electro-conductive cable 26 that connects receiver 22 and electrode sheet 25.

In the present embodiment each target portion of contact detection is set with a unit of part, and each of the plurality of transmitters 24 is installed at each part of contact detection. The parts to be the target of contact detection are those the user can touch or remove among the constitution parts arranged in multi functional peripheral 10, and whose contact history (disassembled history) is highly required to be recorded (refer to FIG. 1). Further, contact history recording system 5 provided in multi functional peripheral 10 of the present embodiment is configured with electrode sheet 25 and electro-conductive cable 26 in addition to said plurality of transmitters 24 and receiver 22.

CPU 11 controls the movement of multi functional peripheral 10 based on a program stored in ROM 12. RAM 13 is used as a work memory to temporarily store various data in cases where CPU 11 executes the program, and also used as an image memory to temporarily store image data.

Hard disk device 14 stores image data obtained by reading original documents, image data (print data) received from an image processing terminal and the like, in addition to various storage data.

Display section 15 configured with a liquid crystal display, etc., displays various screens such as an operation screen, a setting screen, a confirmation screen, a notification screen and the like. Operation section 16 is configured with various buttons such as a start key, a stop key, ten-keys and the like, and a touch panel which is disposed on the surface of the liquid display and detects the pressed coordinate positions. Operation section 16 accepts various operations of multi functional peripheral 10 conducted by a user.

Network I/F section 17 functions as an interface in cases of executing communications with an information processing terminal or a server, etc., through a network as a LAN (Local Aria Network) and the like.

Reading section 18 obtains image data by optically reading an original document. Reading section 18 is configured with such as a light source to irradiate light on the original document, a line image sensor to receive reflection light and read the original of 1 line in the lateral direction, a moving means to sequentially move the reading position by one line unit in the longitudinal direction of the original document, an optical path to guide the reflection light from the original document and focus to form an image on the line image sensor, the optical path being configured with a lens, a miller and the like, and a conversion section to convert the analogue image signals outputted from the line image sensor into digital image data, and the like.

Imager processing section 19 applies various image processing such as rotation, enlargement/reduction, compression/extension and the like.

Image forming section 20 forms and outputs an image on a recording sheet based on the image data through electrophotographic processes. Image fanning section 20 is configured with such as a conveying unit of recording sheet, a photosensitive drum, a charging unit, a LD (Laser Diode) to be controlled and activated based on the inputted image data, a scanning unit to scan the laser beam radiated from the LD on the photosensitive drum, a transfer and separation unit, a cleaning unit and a fixing unit. A printer applying the other system such as a LED printer, which irradiates the photosensitive drum with LED (laser Emitting Diode) instead of the laser beam, can be applicable.

Input/output buffer 21 conducts a buffer function by temporarily stores the inputted data or the data to be outputted in order to compensate a processing speed or a transfer speed in cases of data transfer between each section in multi functional peripheral 10.

Electrode sheet 25 functions as an antenna for conducting the human body communication of the electric field system. Electrode sheet 25, for example, is configured with a sheet body formed of an electro-conductive material, and the surface of the sheet body is covered with an insulation sheet made of an insulating material.

As shown in FIG. 1, electrode sheet 25 is arranged in a prescribed area positioned in front of an installation area of multi functional peripheral 10 and is insulated from a surrounding floor material. The prescribed area includes an area where a person stands in case of contacting the inside of multi functional peripheral 10 from the front side. For example the prescribed area may be an area of prescribed size (for example, a size on which at least one foot of a standing person can be placed) including a position parting by a prescribed distance (for example several tens of centimeters) from multi functional peripheral 10.

In the human body communication of electric field system, since changes of electric field are detected as signals, the human body needs not directly contact the antenna (electrode), thus even in cases where an insulating material exists between the signal path, communications can be conducted. For example even in the case where, such as clothes or shoes intervene between the human body and the apparatus, communications are possible. Further even in the case where, such as carpets or floor materials (floor panel) intervene between the human body and the apparatus, communications are possible. Therefore, electrode sheet 25 may be embedded under the carpet or the floor material, other than being arranged on the floor.

In the front face of multi functional peripheral 10, front cover 27 (open/close front panel) is disposed. Front cover 27 is rotatably arranged such that the low end portion of the cover is axially supported by a frame (or a chassis) of multi functional peripheral 10. Usually, front cover 27 is supported by a latch mechanism or a magnet at a closing position which forms a front surface portion of multi functional peripheral 10. When the upper side of front cover 27 is pulled forward, it rotates to open forward as shown in FIG. 1 with a pivot point of the axially supported portion.

When front cover 27 is left open, internal portions of multi functional peripheral 10 positioned inside the front cover 27 are exposed. In side of this front cover 27, arranged are such as imaging unit 29 being unitized of photosensitive drum 20, movable lever 29 to fix the drum 20 of multi functional peripheral 10, and the like. In the present embodiment, multi functional peripheral 10 is capable of color image formation. Inside multi functional peripheral 10, four imaging units 29 are installed corresponding to four colors of yellow, magenta, cyan, and black. Each imaging unit 29 is fixed at each installation position by being pressed at one side end portion (right side end portion, in the present example) in the front surface with a movable lever disposed at a corresponding portion of multi functional peripheral 10.

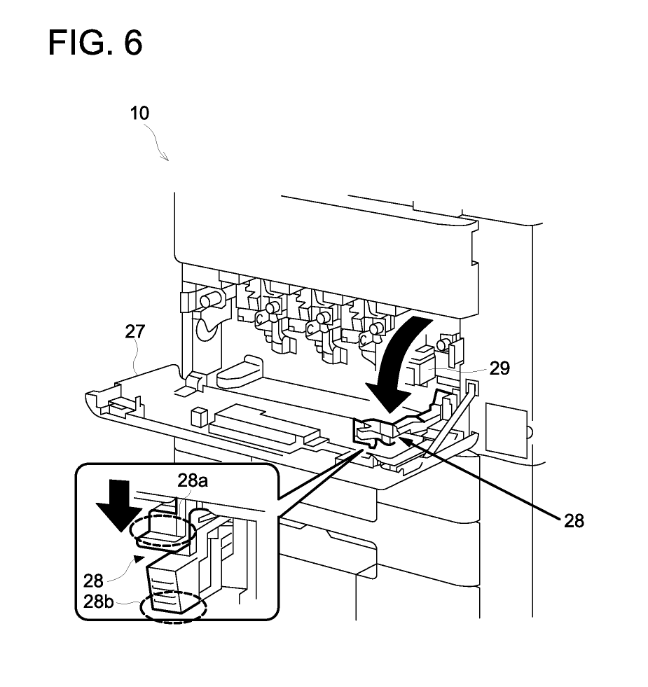

Specifically, movable lever 28 is axially supported at lower end portion of its main body to be rotatably by the frame (or the chassis) of multi functional peripheral 10, and movable lever 28 displaces between the fixed position of upright posture and the released position of forwardly tilted posture where upper end portion of the lever main body is forwardly tilted from the fixed position (refer to FIG. 6). Further, at the upper portion of the lever main body, a rock mechanism is provided.

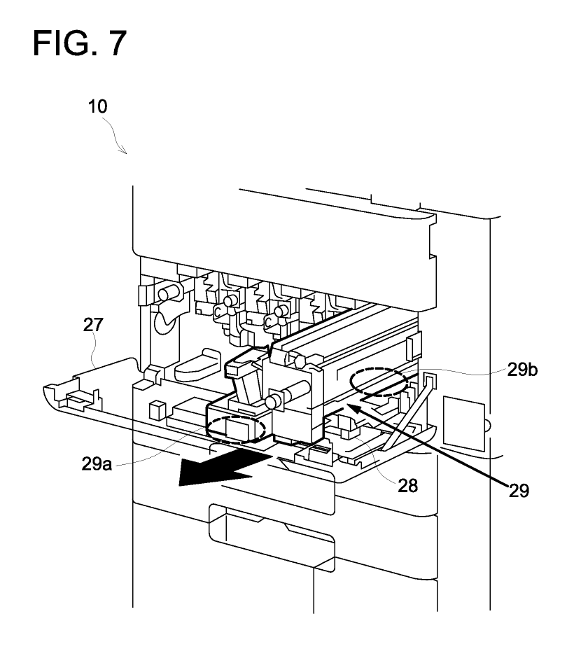

At the fixed position movable lever 28 fixes imaging unit 29 such that movable lever 28 is locked to the frame of multi functional peripheral 10 in the state that the lever main body presses the side end portion in front surface of imaging unit 29. When the lock by the lock mechanism is released and movable lever 28 is tilted and displaces to the releasing position, imaging unit 28 is released by being cleared from the pressing of lever main body. By this, imaging unit 29 is made forwardly extractable, thus imaging unit 29 can be extracted by hand holding the handle portion 29a provided at the front surface of the unit main body (see FIG. 7).

Transmitter 24 is installed at this movable lever 28 or imaging unit 29. Specifically in movable lever 28, for example, transmitter 24 is installed near the operation portion of the lock mechanism which is to be operated by hand when releasing the lock. In imaging unit 29, transmitter 24 is installed at a handle portion, in the front surface of the unit main body, to be held by hand when extracting the unit.

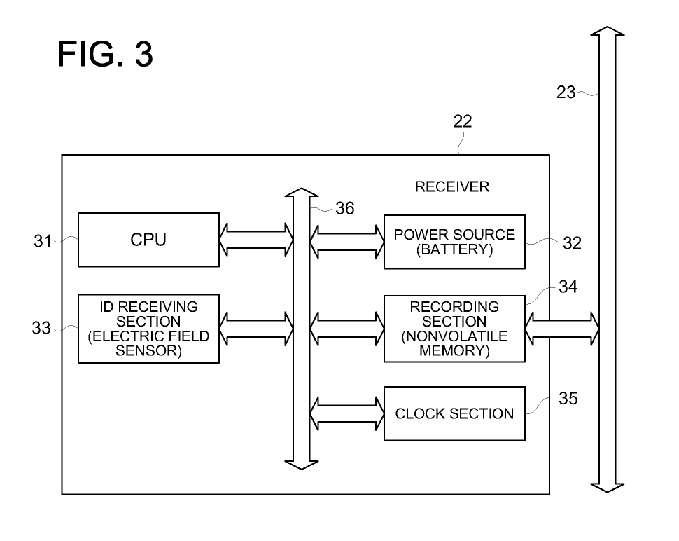

FIG. 3 is a block diagram showing an outline configuration of a receiver 22. Receiver 22 is configured with CPU 31 to control the movement of said receiver 22, power source 32, ID receiving section 33, recording section 34, and clock section 35, each of which being connected via bus 36.

Power source 32 is configured with a battery (secondary cell), and supplies electric power for the movement of each part of receiver 22. For safety sake, error releasing works for multi functional peripheral 10 is usually conducted in the state where the power source (main power) of multi functional peripheral 10 is made OFF or the apparatus is unplugged. Even in this state where the power source is OFF, receiver 22 can work independently with the built-in power source 32. This power source 32 may be structured to be a chargeable battery, and be able to be charged at the time of power ON by supplying power from the power device in the apparatus.

ID receiving section 33 executes the function of data communication with transmitter 24 and terminal apparatus 50 by utilizing the human body as the communication path. ID receiving section 33, communicating with terminal apparatus 50, functions as an acquisition section in the case where receiver 22 acquires personal identification information in terminal apparatus 50. In the case of utilizing the human body communication of electric field system, ID receiving section is configured with the electric field sensor, and has its function. The electric field sensor is configured with such as optical electric field sensor which detects electric signals by converting voltage changes to intensities of light, or TRIDENT™ electric field sensor which detects electric signals by converting voltage changes to magnetic intensities.

Recording section 34 is configured with a nonvolatile memory, and records contact history data (log) of target portion in multi functional peripheral 10. Further, recording section 34 is also connected to bus 23 of multi functional peripheral 10. In multi functional peripheral 10, when in operation state with power source ON, CPU 11 is accessible to recording section 34 to read out the recorded contact history data.

Clock section 35 ticks a time.

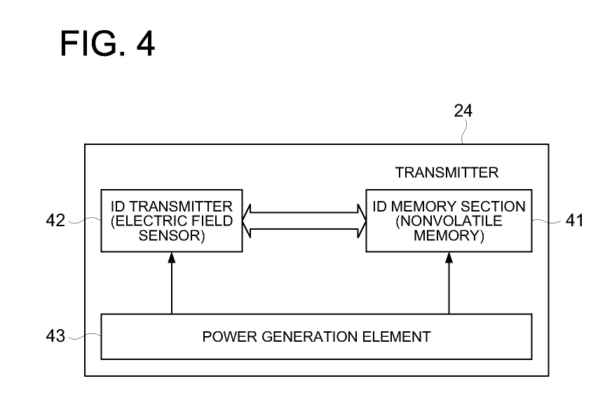

FIG. 4 shows a block diagram of an outline structure of transmitter 24. Transmitter is configured with ID memory section 41, ID transmitting section 42, and power generation element 43.

ID memory section 41 is configured with a nonvolatile memory, and records individual identification information (ID) which being identification information of target portion (part) where the transmitter 24 is installed. The individual ID may be set as a part ID such as control number or name of the part. ID transmitting section 42 conducts data communication with ID receiving section 33 of receiver 22, via a communication path of human body. In the case of utilizing the human body communication of electric field system, similarly to ID receiving section 33, ID transmitting section 42 is configured with the electric field sensor, and has its function. The electric field sensor is configured with such as the TRIDENT™ electric field sensor.

Power generation element 43 generates electric power when being touched by a person, and supplies the power to ID memory section 41 and ID transmitting section 42. The power generation element 43 is configured, for example, such as a piezoelectric element which generates power by converting a kinetic energy, received when being touched by a person, into electric energy, or a temperature difference generation element which generates power by converting a thermal energy, caused by a temperature change when being touched by a person, into electric energy. This power generation element 43 is configured to be the outer peripheral surface of transmitter 24 with enclosing ID memory section 41 and ID transmitting section 42. Regarding ID transmitting section 42, power generation element 43 may be arranged to make electrode portion of the electric field sensor exposed.

Transmitter 24 is structured to be small so as to be attached on the target portion (part). Thus, when a person touches the target portion by hand, and power generation element 43 structuring the outer peripheral of transmitter 24 is touched by a human hand, ID memory section 41 and ID transmitting section 42 is activated by the power supplied from the power generation element 43, and ID transmitting section 42 reads and transmits the individual ID memorized in ID memory section 41. Namely transmitter 24 is configured to transmit the individual ID only when being touched by a person.

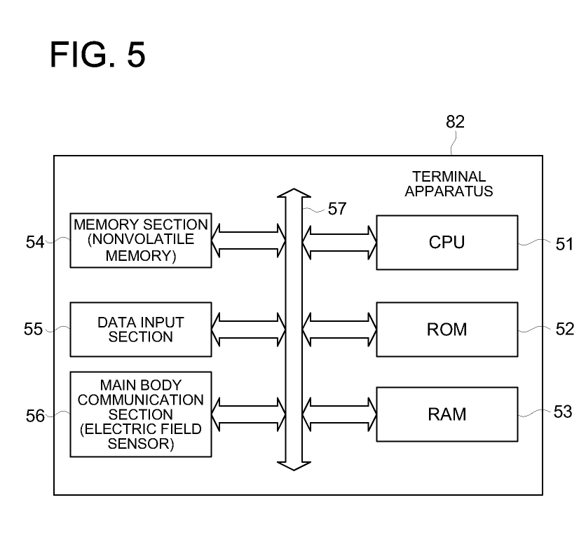

FIG. 5 shows a block diagram of an outline structure of terminal apparatus 50. Terminal apparatus 50 is configured with CPU 51 to control the movement of said terminal apparatus 50, ROM 52, RAM 53, memory section 54, data input section 55 and main body communication section 56, each being connected via bus 57.

ROM 52 stores various programs to be executed by CPU 51, and various data. RAM 53 functions as a work memory to temporarily store various data when CPU 51 executes programs, and as a communication buffer to temporarily store the data relating to transmission/receiving, and the like.

Memory section 54 is configured with a nonvolatile memory, and stores data such as personal identification information (ID) which is identification information of a specific person S carrying said terminal apparatus 50. The personal ID may be a user ID for a service person in case that the person carrying the terminal apparatus 50 is the service person. The personal ID may be a user ID for an administrator (administrator ID) in case that the person carrying the terminal apparatus 50 is the administrator. Data input section 55 is an interface for inputting from externals the data to be stored in memory section 54.

Main body communication section 56 functions to execute data communication with receiver 22 of multi functional peripheral 10 by utilizing a human body as a communication path. In the case of using the human body communication of electric field system, main body communication section 56 is configured with an electric field sensor and has its function similarly to ID receiving section 33 of receiver 22. The electric field sensor is configured with an optical electric field sensor, a TRIDENT™ electric field sensor, or the like.

Further, terminal apparatus 50 of the present embodiment is configured to operate by being supplied electric power from receiver 22 when the terminal apparatus is connected with receiver 22 through the communication path of human body. While, terminal apparatus 50 may be installed with a power source (battery) to independently operate without being supplied a power from receiver 22.

Next, the movement of multi functional peripheral 10 will be described.

As described above, in multi functional peripheral 10, transmitters 24 are installed with the target parts of contact detection (or target portions). For example, in a case where movable lever 28 is set to be a target as shown in FIG. 6, transmitter 24 is installed at the upper face 28a or lower face 28b, those will be inevitably touched by hand when releasing the lock. In a case where imaging unit 29 is set to be a target as shown in FIG. 7, transmitter 24 is installed near the lower face of the handle 29a that will be inevitably touched by hand when imaging unit 29 is extracted. Further, transmitter 24 may be installed at the lower face 29b of the main body of imaging unit that will be highly possible to be touched by hand when imaging unit 29 is extracted. Further, in cases where transmitters 24 are installed at multiple portions of a single part, different individual ID may be allocated to each of the transmitters 24.

Transmitter 24 installed at the target part of contact detection and receiver 22 in multi functional peripheral 10 form a communication path including a human body between one another, when a person, who steps on electrode sheet 25 to connect his/her foot with the electrode, touches by hand the transmitter 24 of target part. In more detail, between transmitter 24 and electrode sheet 25, electrostatic connection state is established with electric field. Between receiver 22, which is connected with electrode sheet 25 via electro-conductive cable 26, and the transmitter 24 established is the electrostatic connection state with electric field via parts (insulator) of multi functional peripheral 10, thus a single circuit is established. The transmitter 24 and the receiver 22, having formed the circuit, execute individual ID transmission/receiving via the communication path of human body side in the circuit. Further, in the case where the person is a specific person S carrying terminal apparatus 50, the terminal apparatus 50 and the receiver 22 form, between each other, a communication path including the human body of the specific person S connected to the electrode sheet 25, and execute transmission and sending of personal ID via the communication path (refer to FIG. 1).

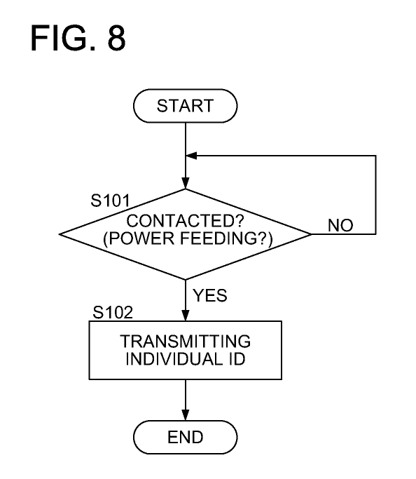

FIG. 8 is a diagram showing the flow of ID transmitting operation of transmitter 24 installed at target parts in multi functional peripheral 10.

Unless being touched by a person, transmitter 24 does not conduct power generation by power generation element 43 and does not operate since power is not supplied to ID memory section 41 and ID transmitting section 42 (step S101; NO). When touched by a person, power generation element 43 conducts self power generation and supply power to ID memory section 41 and ID transmitting section 42 (step S101; YES). The ID transmitting section 42 supplied with the power reads out and transmits individual ID stored in ID memory section 41, thus the present operation finishes (End).

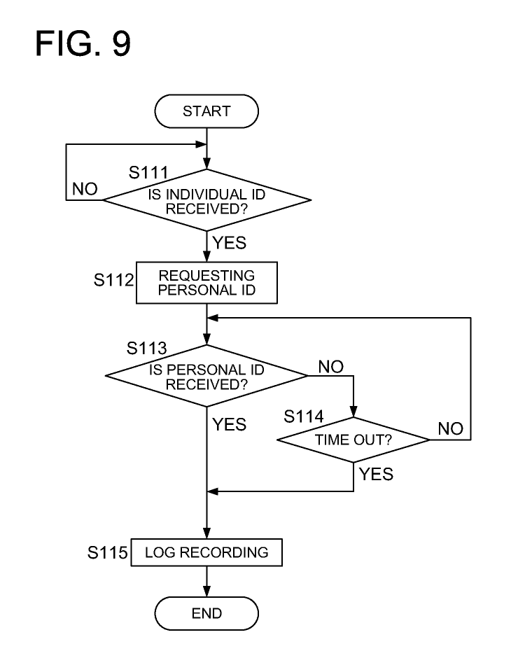

FIG. 9 is a diagram showing the flow of ID receiving operation of the receiver 22 in multi functional peripheral 10.

Receiver 22 is normally in a standby state (step S111; NO), and when ID receiving section 33 receives individual ID (step S111; YES), CPU 31 obtains and keeps the receiving clock time from clock section 35, and requests personal ID (step S112). The request is executed by CPU 31 via ID receiving section 33 to terminal apparatus 50 being capable of communication.

If the personal ID is not received (step S113; NO), and in case of timeout after elapsing a prescribed time period (step S114; YES), CPU 31 correlates the received individual ID and the receiving time of the individual ID and inputs them to recording section 34, and records the log which will be contact history data (step S115), thus the present operation is finished (End). In cases where a regular user, who does not carry terminal apparatus, touches transmitter 24, only individual ID and receiving time information are recorded since personal ID is not received.

In cases where personal ID is received before the timeout (step S112→step S113; YES, or step S112→step S113; NO→step S114; NO→step S113; YES). CPU 31 correlates the received individual ID, receiving time information indicating the receiving time of the individual ID and the received personal ID, and inputs them to recording section 34, and records the log which will be contact history data (step S115), thus the present operation is finished (End). In cases where an administrator or a service person carrying terminal apparatus 50 touches transmitter 24, a personal ID is received after receiving an individual ID, and the individual ID, the receiving time information and the personal ID are recorded.

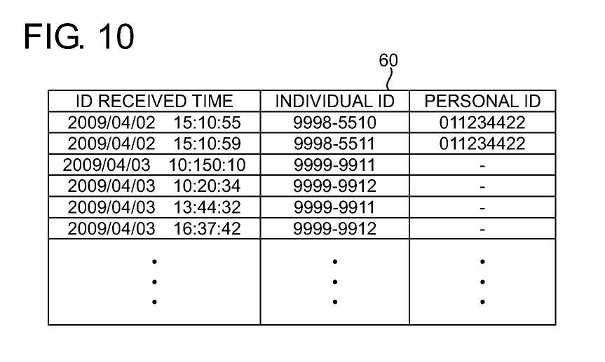

FIG. 10 is a diagram showing an example of log database 60 which being a contact history database recorded in recording section 34 of receiver 22. In the log database 60, the receiving time information (ID receiving time) indicating the receiving time of the individual ID, and the individual ID are correlated and recorded in chronological order of receiving (in order of inputting to recording section 34). In cases where personal ID is available, the personal ID is further correlated and recorded.

Further, multi functional peripheral 10 is capable of displaying the contents of the log database 60 on display section 15 by a prescribed operation in power ON state. From the contents of the log database 60 displayed on display section 15, a service person can figure out the facts of contact or removal of the parts of contact detection target by a regular user or by an administrator.

Although in the log database 60 of FIG. 10, the individual ID is shown as part ID indicating the control number, in cases of displaying the contents of log data base on display section 15, parts name may be displayed in addition to or in replacement of the control number. Display of the part name can be realized for example, by a method where transmitter 24 incorporates a part name into individual ID to be transmitted and records the part name as well, or by a method where a part database, in which a control number and a part name are correlated and registered, is previously stored in receiver 22 or main body of multi functional peripheral 10, and the part name is specified by using the part database.

In this way, according to multi functional peripheral 10 provided with the contact history recording system 5 relating to the present embodiment, by the use of transmitter 24 and receiver 22 those utilizing a human body communication technology, the detection of being touched by a person can be performed with a wireless structure, with an exception of electro-conductive cable 26 for connecting the receiver 22 and the electrode sheet 25. By this configuration, installation space or layout of the transmitter 24 functioning as a contact detection section, and the number of parts to be the contact detection target are improved in the degree of freedom. Further, detailed contact history can be obtained regarding what target part having been touched or what target part having been removed. Therefore, diagnostics and cause investigation of a failure by a service person can be performed surely and promptly, and work hours needed for fixing and restoration can be shortened.

For example, in cases where a user touched a large number of parts, the user may not able to surely explain the parts he touched to a service person arrived, further, in case of worsening the symptom, the service person needs longer time to fix the failure, and there may be a case of incapable cause investigation. However, according to the present embodiment, these problems can be solved.

Since a contact time or a contact person (administrator, etc) can be figured out from the contact history, diagnostics and cause investigation of a failure become easy to conduct. For example, even in cases where a user touched a large number of parts, from the chronological order of contact figured out from the contact time information, the condition of parts removal etc., can be grasped, which is effective for diagnostics and cause investigation of the failure. Further, since work record of the service person can be recorded as the contact history separately from the record of regular user or the administrator, in case where the other service person handles the apparatus, this work record provides effective information.

### Second Embodiment

In the first embodiment, the case is described where the transmitter and the receiver in the contact history recording system communicate with each other by the use of human body communication technology, though in the second embodiment, the case where a radio communication technology is utilized for communication will be described. Here, an example of near field radio communication utilizing noncontact RFID (Radio Frequency Identification) technology will be described.

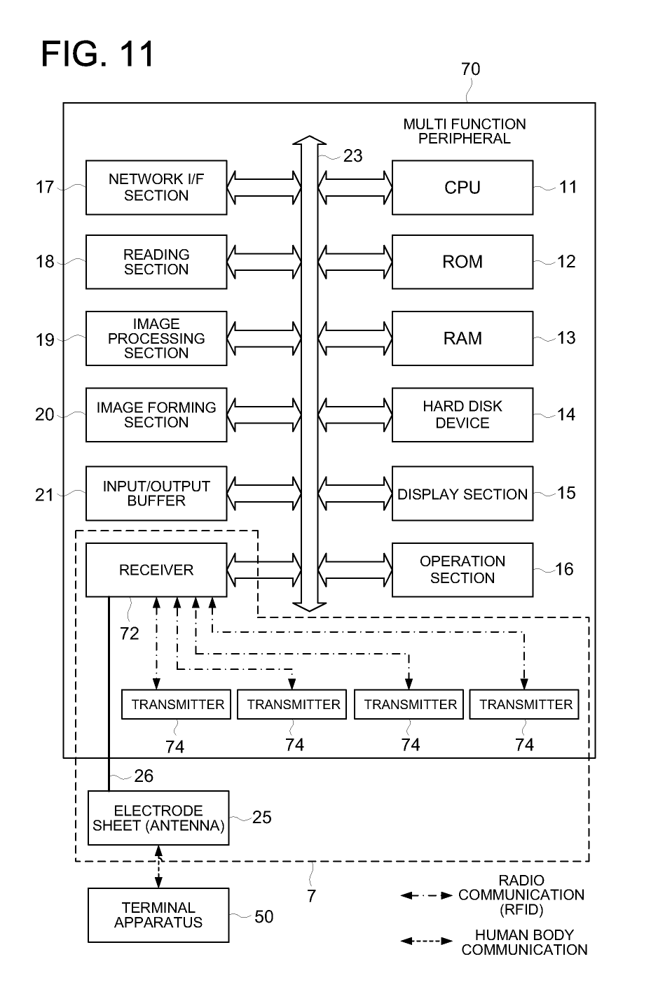

FIG. 11 is diagrams showing a block diagram of the control system of a multi functional peripheral 10 as an image processing apparatus provided with a contact history recording system 7 relating to the second embodiment of the present invention. The present embodiment differs from the first embodiment in the configuration of receiver 72 and transmitter 74, and the others have the same configurations. Here, the explanation of the same configuration as the first embodiment will be omitted, and only contact history recording system 7 including receiver 72 and transmitter 74 will be described.

Contact history recording system 7 is configured with a plurality of transmitters 74 each installed at each target portion (each part) of contact detection in multi functional peripheral 70, receiver 72 to communicate with the plurality of transmitter 74, electrode sheet 25 electro-conductive cable 26 described in the first embodiment. The transmitter 74 and receiver 72 of the present embodiment are provided with radio communication function by RFID. ID receiving section 73 is configured of RFID sensor (RFID tag reader).

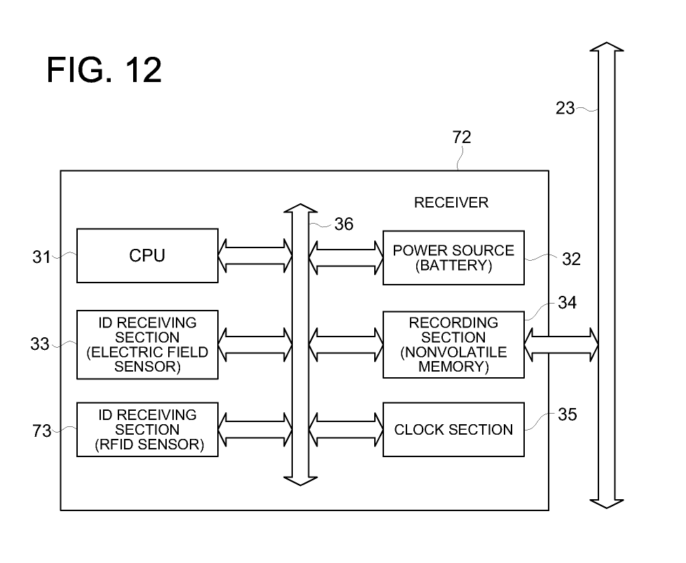

FIG. 12 is a block diagram showing an outline configuration of receiver 72. Receiver 72 is configured with ID receiving section 73 having a function of antenna for radio communication by RFID, in addition to CPU 31, power source 32, ID receiving section 33, recording section 34, and clock section 35 explained in the first embodiment, all being connected via bus 36. ID receiving section 73 is configured of RFID sensor (RFID tag reader).

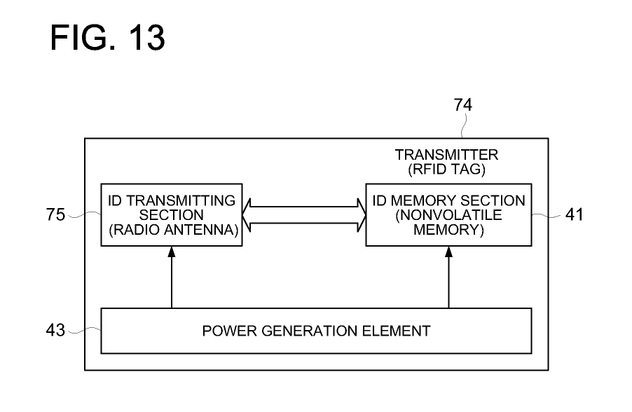

FIG. 13 is a block diagram showing an outline configuration of transmitter 74. Transmitter 74 is configured with ID memory section 41 and power generation element 43 which are explained in the first embodiment, ID transmitting section 75 having a function of antenna for radio communication by RFID, and an RFID tag provided with IC chip (not illustrated) for executing transmission. The RFID tag is an electronic tag provided with an information memory function (data storage function) and communication function (radio communication function). Power generation element 43 generates power when being touched by a person, and supplies power to ID memory section 41, ID transmitting section 75 and IC chip. This power generation element 43 is configured to be the outer peripheral surface of transmitter 74. Transmitter 74 configured with the IC tag is structured to be small so as to be attached on the target portion (part) similarly to the transmitter 24 of the first embodiment.

In the multi functional peripheral 70 provided with the contact history recording system 7, when transmitter 74 is touched by a person, power generation element 43 structuring the outer peripheral of transmitter 74 generates and supplies electric power to ID memory section 41 and ID transmitting section 75 and IC chip. By the power supplied from the power generation element 43, the IC chip is activated and reads the individual ID memorized in ID memory section 41, and transmits from the ID transmitting section 75. Namely transmitter 74 is configured to transmit the individual ID only when being touched by a person, similarly to transmitter 24 in the first embodiment. Receiver 72 operates similarly to the receiver 22 explained in the first embodiment, other than receiving the individual ID transmitted from the transmitter 74 at the ID receiving section 73.

The wireless transmitter and receiver in the contact history recording system can be configured with utilizing the radio communication technology such as the RFID.

### Third Embodiment

As the third embodiment, a variant example will be described in which ID receiving section 33 of receiver 72 described in the second embodiment is replaced with external connection section 83 for communicating with externals.

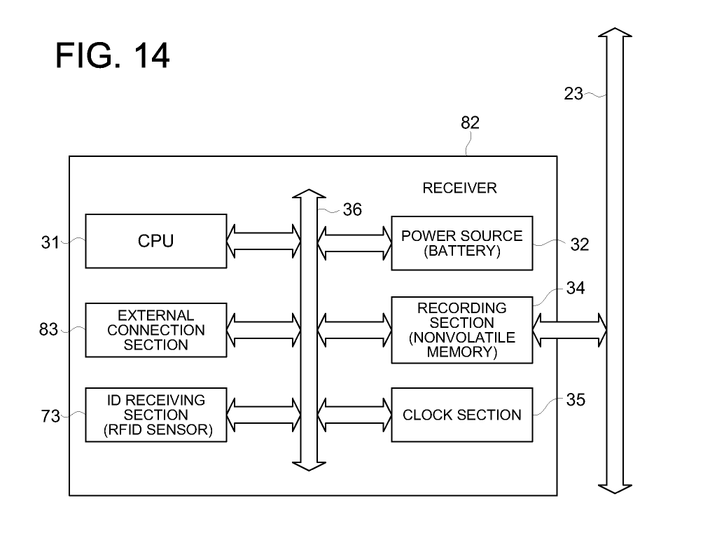

FIG. 14 is a block diagram showing an outline configuration of receiver 82. Compared to receiver 72 described in the second embodiment, in receiver 82, ID receiving section 33 for human body communication is replaced with external connection section 83 having a connecting function with an external memory device and an external terminal (information processing terminal). Receiver 82 is configured to be able to communicate with the external memory device connected to external connection section and the external terminal.

By this configuration, for example, a service person or an administrator is enabled to input the individual ID to receiver 82 and to record in the contact history database (log database) by connecting a USB memory and the like, memorizing his/her personal ID, to external connection section 83 of receiver 82, without utilizing terminal apparatus 50 of human body communication described in the first embodiment. In this case the receiver 22 functions as an acquisition section to acquire the personal ID in the USB memory. Further, the contact history recording system provided with this receiver 82 does not require electrode sheer 25 or electro-conductive cable 26.

Further, by connecting a portable personal computer and the like to external connection section 83 of receiver 82 to access the recording section 34 in receiver 82, the service person can view the content of the log database and store it in the portable personal computer.

Above mentioned external connection section 83 may be provided in the receiver 22 described in the first embodiment. In this case, inputting of personal ID by using the external memory device, viewing the contact history by using the external terminal, and storing it are also made possible.

Although embodiments of the present invention are described as the above by using the drawings, specific configurations are not restricted to the examples shown in the embodiments, and addition or modification without departing from the gist of the present invention will be included in the scope of present invention.

For example, in the contact history recording system explained in the embodiments the recording section to record the contact history is provided in the receiver, however this recording section may be provided outside of the present system. For example, in a case of the receiver provided with the external connection section as explained in the third embodiment, the external memory device connected to the external connection section may be utilized as the above-mentioned recording section. Further, by configuring the receiver to be capable of connecting to a network, a server in the network can be utilized as the recording section.

In the contact history recording system utilizing the human body communication explained in the first embodiment, although the transmitter is configured to be operated by self power generation of the power generation element, another configuration is possible, where the transmitter has not such the self power generation function, and is operated by being supplied power from the receiver.

In the embodiment, the electrode sheet connected to the human body touching the target portion (part) is configured to be connected to the human body via footwear when a person steps on the sheet, however the other configuration will be possible. For example, the electrode may be put on an arm or body (including via clothes) of the person to connect to the human body.

Further, in the embodiments, although the recording section records the contact clock time (receiving time of individual ID), the recording section may further record length of the time period of contact. For example, records the clock times of starting contact and finishing contact, or the receiver records every receiving clock time per one second in cases where the transmitter is configured to periodically transmit the time per one second while being power supplied. In this way, by recording the time period of contact, the service person can easily discriminate whether the part (target portion) has been simply touched by a finger or any work operation such as removal of the parts has been conducted.

Further, in the embodiments, although the receiver acquires and records the personal identification information at the time of contact (at the time of receiving the individual ID), the configuration is possible where the receiver records, at the time of contact, the personal identification information which having been previously obtained before the contact.

The target portion of contact detection is not restricted to be set by unit of part as explained in the embodiments. For example, a plurality of portions on a same part may be segmented and set as the target portions. Further, the target part may be a fixed part, not restricted to movable or detachable parts.

The image processing apparatus relating to the present invention is not restricted to the multi functional peripheral, but other various image processing apparatuses such as a copier, a printer, and a facsimile machine can be the subjects. Further, the contact history recording system relating to the present invention can be provided on various apparatuses not restricting to the image processing apparatus. The various apparatuses includes various equipments such as electric equipment, mechanical equipment and devices structured of multiple parts, in addition to apparatuses of an electronic apparatus and information apparatus and the like.

According to the above described embodiments, a plurality of transmitters are installed at every target portions of contact detection, and when the target portion is touched by a person, a transmitter installed at each of the target portions transmits the previously memorized individual identification information of the target portion. A receiver receives and a control section inputs said individual identification information in a recording section, thus in cases where the target portion is touched by a person, contact history information is recorded. Accordingly, for every target portions of contact detection, the fact of being touched by a person is detected and its contact history is recorded.

By this configuration that the plurality of transmitters functioning as contact detection sections are wirelessly arranged, installation space or layout of the transmitters (contact detection sections) and the number of parts to be the contact detection target are improved in the degree of freedom. Further, detailed contact history can be obtained regarding what target part having been touched or what target part having been removed. Therefore, diagnostics and cause investigation of a failure by a service person can be performed surely and promptly, and work hours needed for fixing and restoration can be shortened.

According to the above described embodiments, clock time information indicating the receiving time of individual identification information can be recorded as the contact history of target portion. This clock time information becomes contact time information indicating the contact clock time when a person touched the target portion. Accordingly, a service person can obtain the contact time for every target portions touched by a user and the like, which makes easy to perform the diagnostics and cause investigation of a failure.

According to the above described embodiments, the personal identification information of the person having contacted the target portion can be recorded as the contact history of target portion. Accordingly, a service person can figure out the contact person for every target portions touched by a user or the service person, which makes easy to perform the diagnostics and cause investigation of a failure.

According to the above described embodiments, the transmitter and the receiver are configured to conduct the transmission and receiving of the individual identification information via the communication path of a human body having contacted the target portion. Namely, the receiving section is connected to an electrode which being connected to a portion of a human body of the person other than a portion with which the person touches the target part. And when the human body connected to the electrode touches the target portion, the transmitter and the receiver establish with each other a communication path including the human body, and via this communication path, transmit and receive the individual identification information. By utilizing such the human body communication path, the configurations of wireless transmitter and receiver are enabled.

According to the above described embodiment, the transmitter and the receiver are configured to conduct the transmission and receiving of the individual identification information via a radio communication. By utilizing such the radio communication, the configurations of wireless transmitter and receiver are enabled.

According to the above described embodiments, the transmitter provided with a power generation element is arranged at the target portion. When a person touches the target portion, the power generation element arranged at the target portion generates electric power and supplies to the transmitting section. When receiving the power, the transmitting section transmits the individual identification information memorized in the memory section. By providing such the power generating element in the transmitter, the transmitter is realized which transmits the individual information only when a person touches the target portion.

According to the above described embodiments, among the plurality of transmitters installed at every target portions, the transmitter, installed at the target portion which is touched by a person, transmits the previously memorized individual identification information of said target portion. The receiver receives this individual identification information, and records in the recording section, thus the contact history can be recorded in the case where the target portion is touched by a person.

What is claimed is:

1. A contact history recording system for recording a contact history for each of target portions of contact detection in an apparatus in cases where the apparatus is contacted by a person, the system comprising:
a plurality of transmitters, each installed at each of the target portions; and
a receiver which communicates with the plurality of transmitter,
wherein each of the plurality of transmitters comprises:
a memory section which previously stores individual identification information of a target portion where a transmitter of the plurality of transmitters is installed; and
a transmitting section which transmits the individual identification information stored in the memory section in cases where the target portion where the transmitter is installed is contacted by a person, and
wherein the receiver comprises:
a receiving section which receives the individual identification information transmitted from the transmitter; and
a control section which inputs the individual identification information received by the receiving section to a recording section to record the inputted individual identification information.

2. The contact history recording system of claim 1, wherein the control section inputs clock time information indicating a clock time of receiving the individual identification information by the receiving section to the recording section, by correlating to the individual identification information.

3. The contact history recording system of claim 1, wherein the receiver comprises an acquisition section to acquire personal identification information of the person, and the control section inputs the personal identification information acquired by the acquisition section into the recording section.

4. The contact history recording system of claim 1, further comprising an electrode connected with the receiving section, the electrode being connected to a portion of a human body of the person other than a portion with which the person touches the target portion,
wherein the transmitter and the receiver form a communication path including the human body of the person between one another, and execute transmission and receiving of the individual identification information via the communication path in cases where the human body connected with the electrode contacts the target portion.

5. The contact history recording system of claim 1, wherein the transmitter and the receiver execute transmission and receiving of the individual identification information via radio communication.

6. The contact history recording system of claim 1, wherein the transmitter comprises a power generation element which generates electric power in cases of being touched by a person and supplies the electric power to the transmitting section, and
wherein the transmitting section transmits the individual identification information in cases of receiving the power supplied by the power generation element.

7. A contact history recording method for recording a contact history for each of target portions of contact detection in an apparatus in cases where the apparatus is contacted by a person, the method comprising:
transmitting previously stored individual identification information of a target portion, from a transmitter installed at the target portion contacted by a person among a plurality of transmitters each installed at each of the target portions;
receiving by a receiver the individual identification information transmitted from the transmitter; and
recording the individual identification information received by the receiver in a recording section.

8. The contact history recording method of claim 7, further comprising the step of recording clock time information indicating a clock time of receiving the individual identification information by the receiver by correlating to the individual identification information.

9. The contact history recording method of claim 7, further comprising:
acquiring personal identification information of the person by the receiver, previously to the step of recording the individual identification information; and
recording the personal identification information acquired by the receiver in the recording section, by correlating to the individual identification information.

10. An image processing apparatus for executing image processing utilizing image data, comprising the contact history recording system of claim 1, wherein each of the target portions is set at each of parts constituting the image processing apparatus.
